(19) United States
(12) Patent Application Publication
(10) Pub. No.: US 2024/0246436 A1
(43) Pub. Date: Jul. 25, 2024

(54) ELECTRIC VEHICLE CHARGING POINT MANAGEMENT EXTENDER

(71) Applicant: Liikennevirta Oy / Virta Ltd, Helsinki (FI)

(72) Inventor: Jussi Ahtikari, Helsinki (FI)

(21) Appl. No.: 18/559,770

(22) PCT Filed: Jun. 3, 2022
(86) PCT No.: PCT/FI2022/050381

§ 371 Date: Nov. 8, 2023

(30) Foreign Application Priority Data
Jun. 8, 2021 (FI) 20215667

(51) Int. Cl. B60L 53/30; B60L 53/65; B60L 53/66; B60L 53/68

(52) U.S. Cl. CPC B60L 53/305; B60L 53/65; B60L 53/665; B60L 53/68

(57) ABSTRACT

An extender for connecting a charging station to a plurality of charging point management systems is disclosed. The extender is connected between a charging station and a charging point management system. The extender is then configured to transmit messages received from the charging station to one or more charging point management systems. This provides a possibility to use services that the original charging point management is not able to perform for various reasons.

### DESCRIPTION OF BACKGROUND

The following disclosure relates to charging stations and charging points for electric vehicles. Particularly, the following disclosure relates to managing charging stations and points.

Electric vehicle charging stations are used to charge electric cars. In the following disclosure, the expression ‘charging station’ is used for an arrangement comprising an appropriate socket for connecting a charging cable to a vehicle. Typically, the charging begins after identifying the user and/or vehicle. The identification may be performed, for example, by using an identification tag, mobile application or using a specific identification arrangement, such as Plug and Charge, wherein the vehicle performs the identification using the charging cable or wireless communication channel after the charging cable has been plugged in.

The charging station communicates with the plugged-in vehicle and a charging point management system (CPMS). Charging stations are connected to one charging point management system. Commonly, the communication is performed using a WebSocket-protocol. The communication is conventionally arranged so that a charging station communicates with a charging point management system using a fixed address or domain name. A charging station and a charging point management system communicate with each other using open charge point protocol (OCPP) messages. The open charge point protocol is an application protocol that is used in communicating between charging stations and the charging point management system or similar central management system.

### SUMMARY

The following disclosure discloses an extender for connecting a charging station to a plurality of charging point management systems. The extender is connected between a charging station and a charging point management system. The extender is then configured to transmit messages received from the charging station to one or more charging point management systems. This provides a possibility to use services that the original charging point management is not able to perform for various reasons.

In an aspect an apparatus is disclosed. The apparatus comprises at least one processor configured to execute computer program code; at least one memory configured to store computer program code; and at least one network interface configured to communicate with a charging station for charging electric vehicles and two or more charging point management systems, wherein the apparatus is further configured to relay messages from the charging station to the two or more charging point management systems and responses thereto in accordance with a predetermined relay scheme. It is beneficial to have an extender between charging stations and charging point management systems so that it is possible to use functionality from a plurality of charging point management system.

In an implementation the at least one memory comprises a whitelist configured to allow relaying messages to one or more of the charging point management systems. It is beneficial to be able to use positive filtering for allowing relaying messages to a particular charging point management system. This reduces transmission of unnecessary messages and improves the functionality of the extender. The reduction of unnecessary messages also reduces the need for computing and waiting responses from different charging point management systems.

In an implementation the at least one memory comprises a blacklist configured to prevent relaying of messages to one or more of the charging point management systems. It is beneficial to be able to use negative filtering for preventing relaying messages to a particular charging point management system. This reduces transmission of unnecessary messages and improves the functionality of the extender. The reduction of unnecessary messages also reduces the need for computing and waiting responses from different charging point management systems.

In an implementation the at least one memory comprises a routing table for at least a position of the message types. It is beneficial to have a separate routing table for routing messages between charging stations and charging point management systems. This reduces transmission of unnecessary messages and improves the functionality of the extender. The reduction of unnecessary messages also reduces the need for computing and waiting responses from different charging point management systems.

In an implementation the routing table comprises at least one message type associated with one or more target charging point management systems and one reply from, wherein the apparatus is configured to relay messages received according to the reply from association to the charging station. It is beneficial to have a routing table that can be used for transmitting messages to several charging point management systems and receiving responses one particular charging point management system. This facilitates sending additional messages to charging point management systems for informative purposes.

In an implementation the at least one memory comprises at least one message specific association, wherein the association determines a primary charging point management system for a message type. It is beneficial to be able to use selective filtering for guiding relaying messages to a particular charging point management system. This reduces transmission of unnecessary messages and improves the functionality of the extender. The reduction of unnecessary messages also reduces the need for computing and waiting responses from different charging point management systems.

In an implementation the apparatus is configured to appear as a charging station to the charging point management systems and as a charging point management system to the charging station. It is beneficial that the extender pretends to be the ordinary counterpart. This removes the need of additional configuration to already existing charging station and charging point management system. Thus, an additional charging point management system can be included in the system without changing any configuration in the charging station and the earlier charging point management system.

In an aspect a system is disclosed. The system comprises a charging point management system and an apparatus as described in the aspect above. It is beneficial to use an extender with a charging point management system as described above so that additional charging point management systems can be added into the system.

In an implementation the system further comprises a charging station. It is beneficial to use the extender particularly between a charging station and a charging point management system so that the charging station can be configured to communicate with a plurality of charging point management systems.

In an implementation the system comprises at least one secondary charging point management system. It is beneficial to use the extender for connecting a charging station to a primary charging point management system and at least one secondary charging point management system, wherein a secondary charging point management system maybe a special purpose management system. This provides a possibility to add functionality into the system.

In an implementation the system further comprises a network redirecting device at the charging station configured to direct the internet connection to the apparatus. It is beneficial to connect the charging station to the extender using a redirecting device. This provides a possibility to connect charging stations with a fixed connection address to a different or a plurality of charging point management systems.

### BRIEF DESCRIPTION OF THE DRAWINGS

The accompanying drawings, which are included to provide a further understanding of the electric vehicle charging point management extender and constitute a part of this specification, illustrate embodiments and together with the description help to explain the principles of the electric vehicle charging point management extender. In the drawings:

FIG. 1 is an example block diagram of an electric vehicle charging arrangement including an electric vehicle charging point management extender,

FIG. 2 is an example of a method for a charging arrangement, and

FIG. 3 is an example of a method for a charging arrangement.

### DETAILED DESCRIPTION

Reference will now be made in detail to the embodiments, examples of which are illustrated in the accompanying drawings.

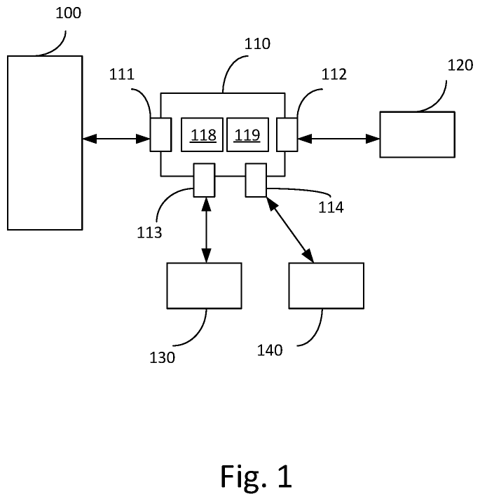

In FIG. 1, an example of a block diagram of an electric vehicle charging arrangement including an electric vehicle charging point management extender is disclosed. In the example of FIG. 1, a charging station 100 is connected to a charging point management system 120. The charging point management system 120 communicates with the charging station 100. For example, when a vehicle is connected to the charging station 100, the charging point management system 120 receives an identification and performs preparatory tasks for initiating the charging. When the charging point management system 120 receives an indication that the charging is finished, the charging point management system 120 will invoice the account associated with the charged vehicle. The connection to the charging point management system 120 is configured over an extender 110. In the example of FIG. 1, the charging point management system 120 is a primary charging point management system. The primary charging point management system may be performing most of the functionality or it may just be the first one that has been connected with the charging station 100.

In the example of FIG. 1, the extender comprises four network interfaces 111-114. The network interface 111 is used in communication with the charging station 100. The network interface 112 is used in communication with the primary charging point management system 120. The network interfaces 113 and 114 are used in communication with secondary charging point management systems. The number of network interfaces is just an example; however, typically the extender is configured to communicate so that one charging station is associated at least two charging point management systems that are sharing the management functionality of a charging station network or a portion of the charging station network. The extender as such can serve a large number of charging stations, however, in the following disclosure the extender is discussed as it was a connecting device between one charging station and two or more charging point management systems. The communication is configured so that other charging stations are not aware of other charging stations. However, any of the charging point management systems can address one or more charging stations by having multiple recipients in their communication. For example, a charging point management system may instruct charging stations to retrieve a software update. This will typically cause a plurality independent update processes, wherein the charging stations independently communicate with the charging point management system or any other instance that has been instructed by the charging point management system.

The example of FIG. 1 shows a simplified extender 110, wherein the network interface 111 is configured to communicate with the charging station 100. The network interface 111 appears to the charging station 110 as a charging point management system. Thus, the extender 110 is configured in a manner that the charging station 100 does not need to be aware that it is connected to an extender 110 instead of being connected directly to the charging point management system 120. When the extender 110 receives a request, such as initiate charging, from the charging station 100, it will pass the message to all charging point management systems 120, 130 and 140 through network interfaces 112-114. Accordingly, the extender 110 appears as a charging point to the charging point management systems. Thus, connected charging point management systems do not need to be aware that they are communicating with an extender 110 instead of the charging station 100. In a simple implementation, the extender copies all of the request and sends the identical request to all three charging point management systems.

Each of the charging point management systems 120, 130 and 140 receive the same request. They process the request and send an appropriate response. The response depends on the services activated in the charging point management system. If the requested service is not activated or implemented in a charging point management system, the charging point management system cannot interpret the received request appropriately. In such a case an error message is sent as a response.

The services may include normal customer related features, charging point maintenance features or any combination of them. The services may be activated because of a technical, business or legal reason. The charging point management systems typically have different feature sets activated. Thus, when the charging station 100 sends a request for initiating a charging session, only one of the charging point management systems can initiate it successfully. If the primary charging point management system 120 is responsible for initiating a charging session, then secondary charging point management systems respond to the request using an error message indicating that charging cannot be initiated with those charging point management systems.

In a simple implementation of the extender 110, the extender provides all of the responses to the charging station 100. The charging station will receive two error messages and one successful initiation message so that it can start the charging procedure. More sophisticated examples are given in the following. In the more sophisticated approaches it is possible to process the error messages in a manner that the charging station receives only those error messages that are relevant and indicating an error situation that should be shown to the user of the charging station. The error messages caused by the use of an extender as such can be omitted.

The example of FIG. 1 is implemented as a service. The actual implementation may be done in a cloud service, a separate server or any other computing resource that is capable of communicating with charging stations using the Internet or a similar network connection. The separate server comprises at least one processor and at least one memory 119. The at least one memory 119 comprises computer program code further comprising instructions for causing the functionality of computer programs. The at least one memory 119 further comprises data relating to the computer programs.

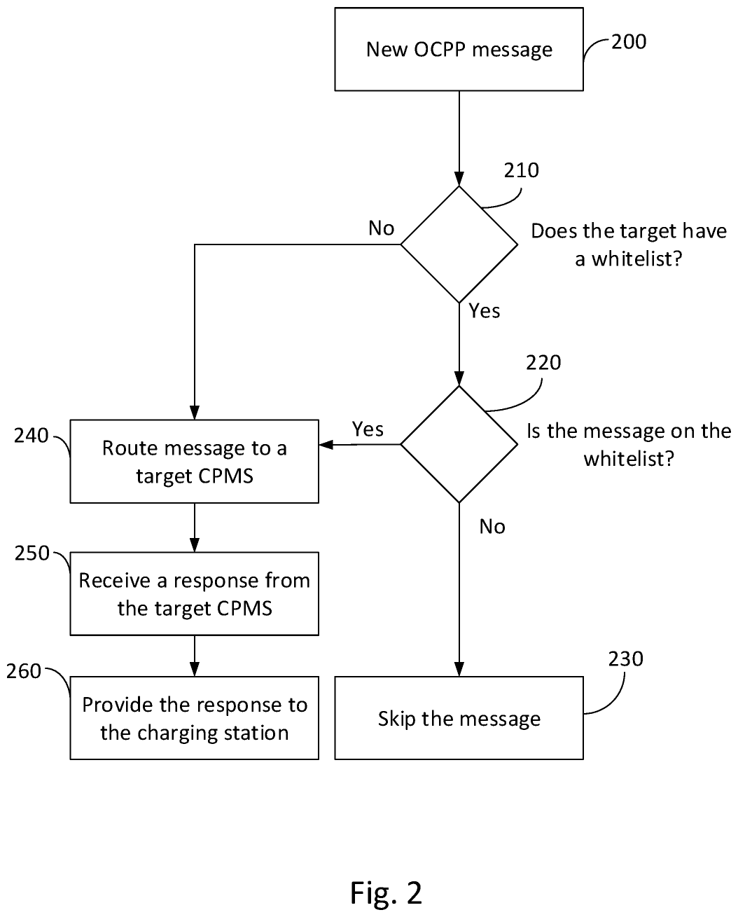

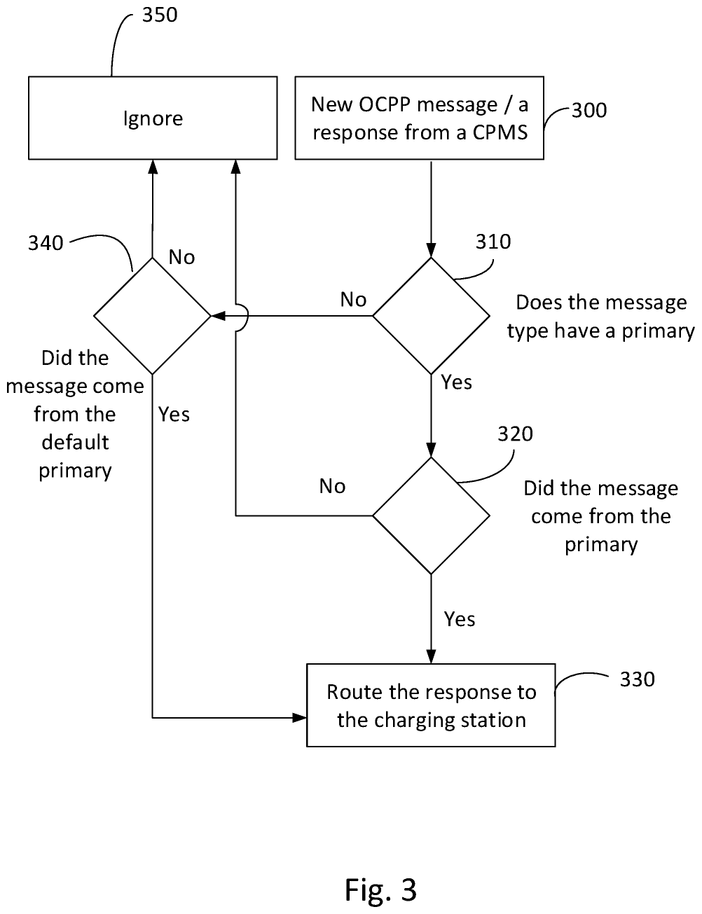

The example of FIG. 1 shows a basic configuration that can be supplemented with additional features as will be explained below. The extender 110 may have a further functionality so that unnecessary error messages are not relayed to the charging station 100. For example, it is possible that the extender 110 collects all received responses and transmits an error message only if all responses are indicating an error situation. When one of the responses is a successful response, it is assumed that the requested action is performed successfully, and the error messages are related to a situation wherein respective charging point management systems are expected to return an error message. The example of FIG. 1 does not have any additional intelligence or functionality to detect the correct destinations of transmitted requests; however, the extender 110 may include a further functionality as will be described in the examples referring to FIGS. 2 and 3.

FIG. 2 discloses a more sophisticated example involving a method that can be implemented in an extender similar to the one discussed above. The extender is similarly arranged to relay messages between a charging station and typically two or more charging point management systems. The method is initiated by receiving an open charge point protocol message, step 200. The message is received at an extender or the like. The extender uses a whitelist to determine a charging point management system to where the message should be routed. There may be more than one destination charging point management systems. This is done by making a comparison of whether the message target has a whitelist, step 210. If the message target does not have a whitelist, the message is routed to the target charging point management system, step 240. If the target does have a whitelist, then it is determined if the message is on the whitelist, step 220. If the message is on the whitelist, the message is routed to the target charging point management system. If the message is not on the whitelist, the message is skipped, step 230. This reduces unnecessary transmission of messages. Skipped messages may be collected to a repository so that an administrator can see them in case of a problem.

When the message is routed to a target charging point management system, the target charging point management system is expected to respond to the message, step 250. This may be an error message as described earlier; however, if the whitelists are complete, the number of error messages is reduced. The received response is then provided to the charging station, step 260. For example, if the messages relate to authorization and starting the charging, the charging station may now initiate charging.

In the example of FIG. 2, the reduction of unnecessary messages is achieved by using a whitelist. A similar functionality may be implemented using blacklists, routing tables or the like, such as a message specific primary setting as explained with regard to the example of FIG. 3 below. A routing table may comprise message specific information. A message type may be associated with a reply from field or setting and a received message is transmitted to the charging station only if the sender is accordance with the routing table. Accordingly, the message specific information contains to which charging point management requests are sent. Furthermore, any combination of those may be used. The extender is described above as a connection between one charging station and one or more charging point management systems. However, if the implementation is done on a server, cloud or the like, the actual physical network interfaces, processors and memories may be shared between a plurality of extender entities.

FIG. 3 discloses an example of a method for a charging arrangement. In the example of FIG. 3, the extender comprises a configuration wherein different message types have been assigned a primary and one or more secondary charging point management systems. The transmission may be configured so that the extender transmits to the primary charging point management system only. In case of a transmission failure, the transmission may be repeated to a secondary charging point management system. Instead of a selective transmission, the extender may be transmitting the message to all of the connected charging point management systems.

The example of FIG. 3 discloses an example wherein a response has been received from one of the charging point management systems, step 300. The message is a standard OCPP-message and the extender is able to detect which charging point management system transmitted the message. First, the message is analyzed and the message type is extracted. The message type is then processed in order to find out if the message type has a message specific primary charging point management system, step 310. If the message type does not have a message specific primary charging point management system, it may be determined whether the message is coming from the default primary charging point management system, step 340. If the message is coming from a secondary charging point management system, then it may be assumed that the response is unintentional or desired to be ignored for any other reason, step 340. For example, if the message type has not been assigned a message type specific primary charging point management system, it may be assumed that this functionality is expected to be performed by the main charging point management system, which is the default primary system. A secondary charging point management system may have the same functionality; however, the owner or operator of the arrangement is not wishing to use this functionality from the secondary charging point management system. If the response is coming from the default primary charging point management system, the response is routed to the charging station, step 330.

If the message has a message specific primary charging point management system, then it is determined if the response is coming from the message specific primary charging point management system. If the message is coming from the message specific charging point management system, the message is routed to the charging station, step 330. If the message is not coming from the message specific charging point management system, the message will be ignored, step 350. The message type specific primary system setting may be implemented as a list or other set of message type and charging point management system associations. As explained above, the message specific setting may be implemented in association with a whitelist, blacklist, routing table or the like. Thus, it is possible to have the message type specific setting only for some of the message types.

In the following one example of a routing table and arrangement suitable for an extender is discussed. Table 1 below shows an example of a routing table that will be explained in more detail in below. The table shown is a particularly beneficial example, however, also different types of routing tables particularly providing the same functionality can be used.

TABLE 1
Routing table example

| Message type | Target CPMS | Reply from |
|---|---|---|
| Default | ALL | Primary |
| Authorize | Primary, AUTH_CPMS | AUTH_CPMS |
| StatusNotification | NOT Auth_CPMS | Primary |

In the example above three routing examples are shown. In a complete case all message types are listed in a routing table, however, it is common that because of changes in different arrangements new message types may be included.

The default message type is an example of a message type covering all messages types that do not have a separate entry. On the table it is shown that default messages are always routed to all charging point measurement systems but only replies received from the primary charging point management system are relayed to the charging station. A second example is an authorization message that is transmitted to a specific authorization charging point management system and the primary charging point management system. Replies are relayed from the authorization charging point management system. The primary charging point management system may be configured, for example, to receive these messages only for statistical reasons. The last example shows a status notification message. Here the responses from all but authorization charging point management system are received.

A complete routing table including all message types is an ideal situation, however, this might not be always possible because of the high number of different message types. Furthermore, configuration changes may be complicated and cause problems with integrity. The routing table discussed above may be supplemented with whitelists and blacklists as discussed above. Furthermore, the routing table arrangement may use grouping and profiling message types. For example, all authorization related message types may be grouped as a profile in the routing table. Now, if the target or reply from configurations need to be changed it is sufficient to change the routing for the whole group or profile and it is not necessary to modify each and every message type. This helps maintaining the integrity in case of larger changes in the system configuration.

Above, arrangements involving an extender between a charging station and one or more charging point management systems have been discussed. The configuration discussed above is particularly beneficial when there is a need for a plurality of charging point management systems. This need may be due from various reasons. For example, the original charging point management system may not have all desired functionality and the operator of the charging station and a charging network may be willing to have additional features in the charging network. In such a case, the additional features may be implemented in a secondary charging point management system so that the operator does not need to make any other technical changes to the earlier configuration. In addition to technical reasons, also a combination of legal and technical reasons may cause a need for a plurality of charging point management systems. An international operator may wish to use the same charging point management functionality for all countries served. However, this may be difficult if the law has provisions with regard to economic reporting, taxes or privacy. For example, a country may require that all personal data of citizens and residents in the country are stored and maintained in the country and not transmitted to any other countries.

The above mentioned method may be implemented as computer software which is executed in a computing device able to communicate with a mobile device. When the software is executed in a computing device, it is configured to perform the above described inventive method. The software is embodied on a computer readable medium so that it can be provided to the computing device, such as the extender 110 of FIG. 1.

As stated above, the components of the exemplary embodiments can include a computer readable medium or memories for holding instructions programmed according to the teachings of the present inventions and for holding data structures, tables, records, and/or other data described herein. A computer readable medium can include any suitable medium that participates in providing instructions to a processor for execution. Common forms of computer-readable media can include, for example, a floppy disk, a flexible disk, hard disk, magnetic tape, any other suitable magnetic medium, a CD-ROM, CD±R, CD±RW, DVD, DVD-RAM, DVD±RW, DVD±R. HD DVD, HD DVD-R. HD DVD-RW, HD DVD-RAM, Blu-ray Disc, any other suitable optical medium, a RAM, a PROM, an EPROM, a FLASH-EPROM, any other suitable memory chip or cartridge, a carrier wave or any other suitable medium from which a computer can read.

It is obvious to a person skilled in the art that with the advancement of technology, the basic idea of the electric vehicle charging point management extender may be implemented in various ways. The electric vehicle charging point management extender and its embodiments are thus not limited to the examples described above; instead they may vary within the scope of the claims.

1. An apparatus comprising:
at least one processor configured to execute computer program code;
at least one memory configured to store computer program code; and
at least one network interface configured to communicate with a charging station for charging electric vehicles and two or more charging point management systems, wherein
the apparatus is further configured to relay messages from the charging station to the two or more charging point management systems and responses thereto in accordance with a predetermined relay scheme.

2. An apparatus according to claim 1, wherein the at least one memory comprises a whitelist configured to allow relaying messages to one or more of the charging point management systems.

3. An apparatus according to claim 1, wherein the at least one memory comprises a blacklist configured to prevent relaying of messages to one or more of the charging point management systems.

4. An apparatus according to claim 1, wherein the at least one memory comprises a routing table for at least a position of the message types.

5. An apparatus according to claim 4, wherein the routing table comprises at least one message type associated with one or more target charging point management systems and one reply from, wherein the apparatus is configured to relay messages received according to the reply from association to the charging station.

6. An apparatus according to claim 1, wherein the at least one memory comprises at least one message specific association, wherein the association determines a primary charging point management system for a message type.

7. An apparatus according to claim 1, wherein the apparatus is configured to appear as a charging station to the charging point management systems and as a charging point management system to the charging station.

8. A system comprising a charging point management system and an apparatus according to claim 1.

9. A system according to claim 8, wherein the system further comprises a charging station.

10. A system according to claim 8, wherein the system comprises at least one secondary charging point management system.

11. A system according to claim 8, wherein the system further comprises a network redirecting device at the charging station configured to direct the internet connection to the apparatus.

12. A method for managing charging stations in an electric vehicle charging network comprising:
receiving a message from a charging station;
transmitting the received message to two or more charging point management systems;
receiving a response to the transmitted message; and
transmitting the received response to the charging station.

13. A method according to claim 12, wherein the received message is transmitted to all of the two or more charging point management systems.

14. A method according to claim 12, wherein the received message is transmitted to charging point management systems based on at least one of the following: a whitelist, a blacklist or a routing table.

15. A computer program comprising a computer program code, wherein the computer program code comprises instructions to cause a method according to claim 12 when executed on a computing device.
